(19) United States
(12) Patent Application Publication
(10) Pub. No.: US 2026/0273439 A1
(43) Pub. Date: Sep. 17, 2026

(54) HYDROCYCLONE DEGASSING DEVICE

(71) Applicant: R + L UG (HAFTUNGSBESCHRÄNKT), Riedering (DE)

(72) Inventors: Robert STAUDACHER, Rohrdorf (DE); Ludwig WIESBÖCK, Rohrdorf (DE); Simon DAXLBERGER, Riedering (DE); Hans ITTLINGER, Bad Endorf (DE)

(21) Appl. No.: 19/562,345

(22) Filed: Mar. 10, 2026

(30) Foreign Application Priority Data
Mar. 11, 2025 (DE) 10 2025 109 258.3

(51) Int. Cl. B01D 19/00

(52) U.S. Cl. CPC B01D 19/0057; B01D 19/0063

(57) ABSTRACT

The present disclosure discloses a hydrocyclone degassing device for degassing a liquid, comprising a degassing vessel in which, during operation, along an axis of rotation, an outer liquid cyclone and an inner gas cyclone form, wherein the degassing vessel comprises at least one inlet for the liquid, at least one outlet for the liquid, and at least one discharge opening for discharging gas. It is provided here that the hydrocyclone degassing device is configured such that, for discharging gas from the degassing vessel, the liquid flow from the degassing vessel is stopped and/or reduced so that the liquid level within the degassing vessel rises due to the liquid flowing in via the inlet.

### CROSS REFERENCE TO RELATED APPLICATION

The present application claims priority to German Patent Application No. 10 2025 109 258.3 filed on Mar. 11, 2025. The entire contents of the above-listed application are hereby incorporated by reference for all purposes.

### TECHNICAL FIELD

The present disclosure relates to a hydrocyclone degassing device for degassing a liquid.

### BACKGROUND

Hydrocyclone degassing is a vacuum degassing in which the liquid to be degassed is brought into contact with a negative pressure in order to remove the gases contained in the liquid.

### SUMMARY

Important criteria for the efficiency of a vacuum degassing are a large contact surface between the liquid to be degassed and the vacuum, the lowest possible pressure level, and the longest possible residence time.

In the field of vacuum degassing, a number of different methods already exist, each with specific advantages and disadvantages.

On the one hand, degassing can be carried out via a semipermeable membrane with or without stripping gas. This enables very high degassing performance and the removal of dissolved gases down into the range of trace gases. However, vacuum degassing via a semipermeable membrane is susceptible to contamination and is only useful with pre-cleaned liquids. Furthermore, there are high acquisition costs.

Another technique uses vacuum spray-tube degassers, in which the liquid is sprayed in a vacuum. Here too, high degassing performance can be achieved. However, the method is likewise susceptible to contamination because the degassing performance depends on the spray nozzle, which requires narrow cross-sections. Furthermore, the quality of the degassing is limited.

Furthermore, degassing can take place according to the injector principle by reducing pressure by means of high flow velocities.

In hydrocyclone degassing, the liquid is conducted into a degassing vessel in which, due to the flow geometry used, an outer liquid cyclone and an inner gas cyclone form. Hydrocyclone degassing places low demands on water quality and thus tolerates contamination better than the processes mentioned above.

In hydrocyclone degassing devices known from the prior art, gas is withdrawn from the gas cyclone by applying a negative pressure. Furthermore, degassing with a hydrocyclone degassing device is a continuous process.

Patent document DE 36 41 781 A1 shows a hydrocyclone degassing device in which both the inlet pipe and the outlet pipe are arranged tangentially on the shell of the degassing vessel. In this case, the liquid is supplied to the hydrocyclone at a minimum pressure of 6 to 8 bar.

Patent document GB 2 440 726 A shows a hydrocyclone degassing device with a special geometry of the degassing vessel.

Patent document DE 10 2016 011 540 B3 shows a vortex tube for separating a fluid stream. Patent document DE 10 2017 113 888 B3 shows a centrifugal separator for fluid separation.

Patent documents DE 10 2021 107 660 A1, CH 319 593 A, and DE 30 22 420 A1 each show hydrocyclone degassing devices with a tangential inlet into and an axial outlet out of the degassing vessel. In part, a liquid pump was further provided here, which generates the liquid flow from the degassing vessel and which is connected on its suction side to the outlet of the degassing vessel.

However, the degassing quality in hydrocyclone degassing devices according to the prior art was relatively low.

The object of the present disclosure is to provide a hydrocyclone degassing device with improved properties.

This object is achieved by hydrocyclone degassing devices as described herein.

The present disclosure comprises a hydrocyclone degassing device for degassing a liquid, comprising a degassing vessel in which, during operation, an outer liquid cyclone and an inner gas cyclone form along an axis of rotation, wherein the degassing vessel comprises at least one inlet for the liquid, at least one outlet for the liquid, and at least one discharge opening for discharging gas. According to the disclosure, the hydrocyclone degassing device is configured such that, for discharging gas from the degassing vessel, the liquid flow from the degassing vessel is stopped and/or reduced so that the liquid level within the degassing vessel rises due to the liquid flowing in via the inlet.

Due to the rising liquid level within the degassing vessel, the pressure within the degassing vessel rises and the gas located in the degassing vessel is pressed at least partially through the discharge opening.

According to the disclosure, on the one hand, no negative-pressure source is necessary any longer in order to draw the gas out of the degassing vessel. The construction therefore becomes significantly simpler. In addition, the inventors have recognized that by such an approach the quality of the degassing without a negative-pressure source can be significantly increased compared with the prior art

According to an embodiment of the present disclosure, the hydrocyclone degassing device comprises a controller which controls the liquid flow from the degassing vessel such that, in a first operating phase, the liquid level is lowered by the liquid flow from the degassing vessel and a negative pressure is generated in the degassing vessel, wherein an outer liquid cyclone and an inner gas cyclone form along an axis of rotation, and, in a second operating phase, the liquid flow from the degassing vessel is stopped and/or reduced so that the liquid level within the degassing vessel rises due to the liquid flowing in via the inlet, wherein gas is discharged from the discharge opening. Through these two operating phases, a simple control results. In addition, the quality of the degassing can be increased considerably.

According to an embodiment of the present disclosure, the controller is configured such that the hydrocyclone degassing device is operated alternately in the first and the second operating phase.

According to an embodiment of the present disclosure, the controller is in particular configured such that the hydrocyclone degassing device is operated in a continuous alternation between the first and second operating phase. In particular, the hydrocyclone degassing device is operated here without interposed inactive phases. Due to the simple design and the simple control, the hydrocyclone degassing device according to the disclosure is particularly well suited for such continuous operation.

According to an embodiment of the present disclosure, the controller initiates the change from the first to the second operating phase, i.e. in particular the stopping and/or reducing of the liquid flow from the degassing vessel, in a time-controlled manner. In particular, pressure sensors within the degassing vessel, which are used, for example, for control in spray-tube degassing installations, can thereby possibly be dispensed with. For the discharge of the gas from the degassing vessel taking place in the context of the second operating phase, however, a pressure control can also be used in one possible embodiment, as will be described below. Furthermore, the discharge of the gas from the degassing vessel taking place in the context of the second operating phase can also take place in a mechanically controlled manner, for example by the mechanical action of the liquid level and/or the pressure on a valve, or in a time-controlled manner.

According to a first embodiment of the present disclosure, a liquid pump that generates the liquid flow from the degassing vessel is always operated in the first operating phase with the same volumetric flow rate and/or the same power. In particular, the liquid pump can be a liquid pump which has exclusively the task of generating the liquid flow from the degassing vessel and/or which is arranged in a line of a secondary circuit in which the degassing vessel is arranged.

According to an embodiment and in particular the first embodiment of the present disclosure just described, the controller switches from the first to the second operating phase at fixed time intervals. As a result, a particularly simple control becomes possible, which nevertheless provides good degassing results.

According to a second embodiment of the present disclosure, a liquid pump which generates the liquid flow from the degassing vessel is operated in the first operating phase with a variable volumetric flow rate and/or a variable power and/or independently of the operation of the hydrocyclone degassing device. In particular, the liquid pump here can be the liquid pump of a main circuit to which a secondary circuit with the degassing vessel is connected.

According to an embodiment and in particular the second embodiment of the present disclosure just described, the time intervals at which the controller switches from the first to the second operating phase depend on an operating value of the liquid pump and/or a value of the liquid flow from the degassing vessel, and in particular on a volumetric flow rate and/or a power of the liquid pump. As a result, the operation of the hydrocyclone degassing device can be adapted to a varying operation of the liquid pump and/or a varying liquid flow from the degassing vessel.

According to an embodiment of the present disclosure, the hydrocyclone degassing device comprises a valve arranged in an outlet line, via which the liquid flow from the degassing vessel is controlled. This enables a particularly simple control of the liquid flow from the degassing vessel. The valve here optionally comprises an actuator, in particular an electric drive, which is actuated by the controller.

In particular, the valve is a switching valve which can switch back and forth between an open state and a closed state, in particular in order to switch back and forth between the first and the second operating phase.

According to an embodiment of the present disclosure, the control of the liquid flow from the degassing vessel and/or the control for switching between the first and the second operating phase takes place exclusively by the valve, while a liquid pump which generates the liquid flow from the degassing vessel is operated independently of the operation of the hydrocyclone degassing device and/or independently of the switching between the operating phases. In one possible embodiment of the present disclosure, the liquid pump is operated here with constant power and/or rotational speed and/or is also operated further during the second operating phase.

According to an embodiment of the present disclosure, the hydrocyclone degassing device comprises a liquid pump which generates the liquid flow from the degassing vessel.

According to an embodiment of the present disclosure, the liquid pump is connected with its suction side to the outlet of the degassing vessel. The liquid pump thereby generates a negative pressure in the degassing vessel.

According to an embodiment of the present disclosure, the liquid pump has a suction head of at least 1 m, more optionally of at least 2 m, more optionally of at least 5 m, and more optionally of at least 8 m or 9 m. The suction head can be below 20 m, more optionally below 15 m.

According to an embodiment of the present disclosure in which a valve for controlling the liquid flow is provided, the valve is optionally arranged on the pressure side of the liquid pump. Dry running of the liquid pump is thereby prevented. This arrangement is chosen in particular when the liquid pump, together with the degassing vessel, is arranged in a secondary circuit.

According to an alternative embodiment of the present disclosure in which a valve for controlling the liquid flow is provided, the valve is arranged on the suction side of the liquid pump. This arrangement is chosen in particular when the liquid pump is arranged in a main circuit and the degassing vessel is arranged in a secondary circuit.

According to an embodiment of the present disclosure, at the discharge opening at least one valve is provided which allows a discharge of the gas. In particular, depending on the switching position, the at least one valve allows a build-up of a negative pressure in the degassing vessel and a discharge of the gas from the degassing vessel.

According to an embodiment of the present disclosure, the gas is released into the environment by an overpressure in the degassing vessel and/or without a negative-pressure source connected to the discharge opening.

According to an embodiment of the present disclosure, the hydrocyclone degassing device is configured such that the at least one valve is closed for generating negative pressure in the degassing vessel by the liquid flow and/or at least during a part of the first operating phase and/or opens for discharging the gas from the degassing vessel and/or during at least a part of the second operating phase.

According to an embodiment of the present disclosure, the valve is a float valve.

According to a first embodiment of the present disclosure, the at least one valve is not actuated by the controller.

According to an embodiment and in particular the first embodiment of the present disclosure, the at least one valve is actuated mechanically by the liquid level and/or the pressure in the degassing vessel.

According to an embodiment and in particular the first embodiment of the present disclosure, the valve comprises a float valve and/or a check valve.

According to an alternative embodiment of the present disclosure, the at least one valve is actuated by the controller. The actuation can be time-controlled and/or pressure-controlled.

According to an embodiment of the present disclosure, the degassing vessel is configured such that the liquid flows tangentially into the degassing vessel via the at least one inlet.

According to an embodiment of the present disclosure, the degassing vessel is configured such that the liquid is withdrawn axially from the degassing vessel via the at least one outlet.

According to a possible embodiment, the at least one inlet is provided in an inlet ring which adjoins axially at least one shell element of the degassing vessel.

The inlet geometry can thereby be arranged in a separate element, which simplifies the structure of the degassing vessel.

According to a possible embodiment, the inlet ring is arranged between two shell elements of the degassing vessel.

According to a possible embodiment, the inlet ring comprises a plurality of inlets distributed over the circumference, which optionally open tangentially into an inner circumferential surface of the inlet ring.

According to a possible embodiment, the inlet ring comprises an inner circumferential surface into which the inlet or inlets open. The inner circumferential surface of the inlet ring optionally forms a part of the inner circumferential surface of the degassing vessel.

According to a possible embodiment, it is provided that the inner circumferential surface of the inlet ring adjoins the inner circumferential surface of the at least one shell element and optionally is flush with it.

According to a possible embodiment, the at least one inlet is arranged in a region between an axial center of the degassing vessel and an axial end at which the discharge opening is provided.

According to a possible embodiment, the at least one inlet is arranged axially spaced from an axial position of the discharge opening in the axial direction toward the outlet side, in particular by at least 5%, optionally at least 10% of the axial extent of the degassing vessel.

Due to the spaced arrangement, it is prevented that liquid emerges through the discharge opening and/or that the cyclone in the degassing vessel is adversely affected.

According to a possible embodiment, the cross-section of an inlet channel which leads to the inlet into the degassing vessel decreases continuously at least over a partial region of its extent. The inlet channel can here be formed in particular conically or hyperbolically.

According to a possible embodiment, in an inlet line to the at least one inlet into the degassing vessel a primary swirl element is provided.

According to a possible embodiment, at least two inlets into the degassing vessel are provided. These can each be configured as described for the at least one inlet.

According to a possible embodiment, the primary swirl element is arranged at the inlet of an inlet channel which leads to the inlet. In particular, the primary swirl element can swirl the liquid before it flows through the inlet into the degassing vessel. In one possible embodiment, this can take place in that the primary swirl element allows the liquid to flow tangentially into the inlet channel.

According to a possible embodiment, the primary swirl element comprises at least one primary swirl housing with at least one tangential inlet and/or an axial outlet.

According to a possible embodiment, at least two inlets into the primary swirl housing are provided. These can each be configured as described for the at least one inlet.

According to a possible embodiment, the cross-section of an inlet channel which leads to the inlet into the primary swirl housing decreases continuously at least over a partial region of its extent. The inlet channel can here be formed in particular conically or hyperbolically.

According to a possible embodiment, the inlet channel which leads to the inlet into the degassing vessel adjoins axially the axial outlet of the primary swirl housing.

According to a possible embodiment, the degassing vessel comprises an upper closure plate provided with a central bore, wherein optionally the central bore of the upper closure plate forms the discharge opening.

According to a possible embodiment, the degassing vessel comprises a lower closure plate provided with a central bore, wherein optionally the central bore of the lower closure plate forms the outlet for the liquid.

According to a possible embodiment, the degassing vessel comprises a rotationally symmetrical interior space. Optionally, along its axial extent, it has a shape that is at least in partial regions cylindrical, conical, and/or hyperbolic.

According to a possible embodiment, the degassing vessel has a cylindrical basic shape along its axial extent. This allows a particularly simple construction.

According to a possible embodiment, the degassing vessel comprises at least one circular-cylindrical shell element.

Optionally, the degassing vessel comprises at least two circular-cylindrical shell elements.

Optionally, the one or more shell elements adjoin an inlet ring as described above.

The present disclosure further comprises a pump assembly with a liquid pump and a hydrocyclone degassing device as described above. In particular, this is a pump assembly for a heating and/or cooling circuit.

According to a possible embodiment, the liquid pump is arranged here in a main circuit and the degassing vessel is arranged in a secondary circuit in parallel with the liquid pump.

The present disclosure further comprises a liquid circuit with a hydrocyclone degassing device as described above.

In particular, the liquid circuit can be a heating and/or cooling circuit.

According to a possible embodiment, the degassing vessel is arranged in a secondary circuit parallel to a main circuit. As a result, the hydrocyclone degassing device can be operated intermittently without this restricting and/or influencing the operation of the main circuit.

According to a first possible embodiment, in the secondary circuit downstream of the degassing vessel a liquid pump is arranged, wherein the liquid flow from the degassing vessel is controlled by controlling the liquid pump and/or by controlling a valve which is arranged in the secondary circuit downstream of the degassing vessel and optionally downstream of the liquid pump.

According to an embodiment and in particular the first possible embodiment, the operation of the hydrocyclone degassing device takes place independently of an operation of a main pump of a main circuit.

According to an embodiment and in particular the first possible embodiment, the secondary circuit is arranged on a return line of a main circuit.

According to a second possible embodiment, in the main circuit parallel to the secondary circuit a liquid pump is arranged which generates in the secondary circuit the liquid flow from the degassing vessel.

According to an embodiment and in particular the second possible embodiment, the liquid flow from the degassing vessel is controlled by actuation by actuation of a valve which is arranged in the secondary circuit downstream of the degassing vessel.

According to an embodiment and in particular the second possible embodiment, the operation of the hydrocyclone degassing device takes place depending on an operation of the liquid pump of the main circuit.

The present disclosure further comprises a method for operating a hydrocyclone degassing device and/or a pump assembly and/or a liquid circuit as described above. Here, for discharging gas from the degassing vessel, the liquid flow from the degassing vessel is stopped and/or reduced so that the liquid level within the degassing vessel rises due to the liquid flowing in via the inlet.

According to a possible embodiment, the liquid flow from the degassing vessel is controlled such that, in a first operating phase, the liquid level is lowered by the liquid flow from the degassing vessel and a negative pressure is generated in the degassing vessel, wherein, along an axis of rotation, an outer liquid cyclone and an inner gas cyclone form, and, in a second operating phase, the liquid flow from the degassing vessel is interrupted and/or reduced so that the liquid level within the degassing vessel rises due to the liquid flowing in via the inlet, wherein gas is discharged from the discharge opening.

The operation can take place in particular as already described above.

Furthermore, a hydrocyclone degassing device can be used as described above.

According to a possible embodiment, within the degassing vessel no rotating element is provided. Therefore, only the liquid and the gas rotate, but no components of the hydrocyclone degassing device.

According to a possible embodiment, no moving parts are provided within the degassing vessel.

According to a possible embodiment, in the hydrocyclone degassing device according to the present disclosure no membrane is provided. The separation between liquid and gas instead takes place via the cyclone.

According to a possible embodiment, the controller comprises a microcontroller and a non-volatile memory with a computer program which, when it runs on the microcontroller, provides the functions of the controller described above and/or carries out the operation of the hydrocyclone degassing device described above.

According to a possible embodiment, the control of the hydrocyclone degassing device by the controller takes place automatically.

The present disclosure will now be described in more detail with reference to exemplary embodiments and drawings.

### BRIEF DESCRIPTION OF THE FIGURES

The Figures show in:

FIG. 0A: a first exemplary embodiment of a hydrocyclone degassing device according to the disclosure, a pump assembly according to the disclosure, and a liquid circuit according to the disclosure,

FIG. 0B: a second exemplary embodiment of a hydrocyclone degassing device according to the disclosure, a pump assembly according to the disclosure, and a liquid circuit according to the disclosure,

FIG. 1: an exemplary embodiment of a degassing vessel as can be used in one of the hydrocyclone degassing devices according to the disclosure, in a perspective view,

FIG. 2: the exemplary embodiment of the degassing vessel shown in FIG. 1 in a sectional view,

FIG. 3: a perspective view of an inlet ring used in the context of the disclosure,

FIG. 4: a sectional view of the inlet ring shown in FIG. 3,

FIG. 5: a plan view of a primary swirl element arranged on an inlet according to the disclosure,

FIG. 6: the exemplary embodiment of a primary swirl element shown in FIG. 5 in a sectional view.

### DETAILED DESCRIPTION

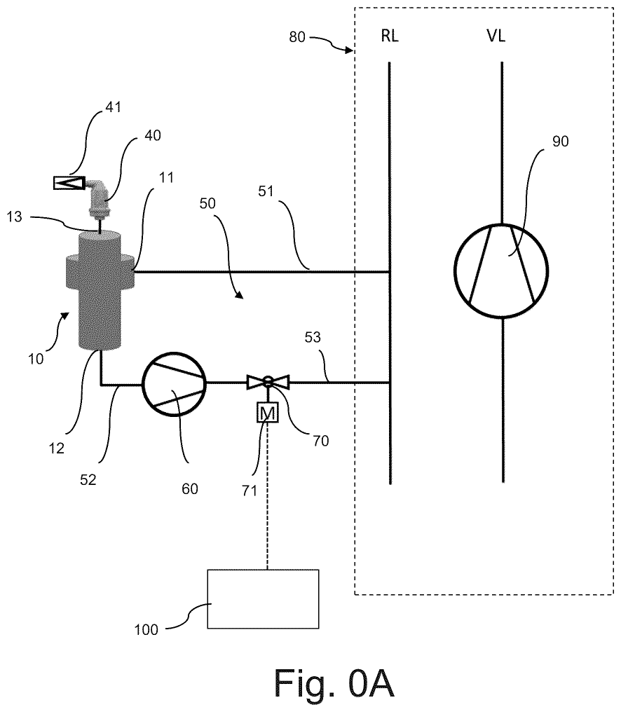

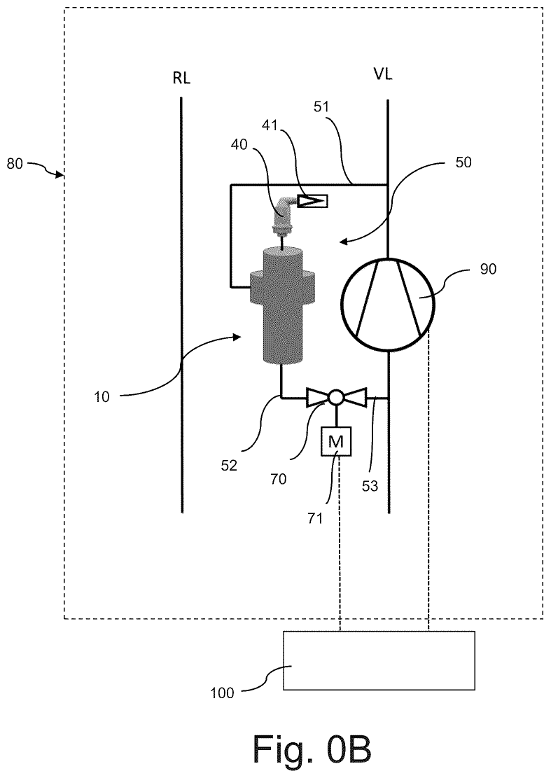

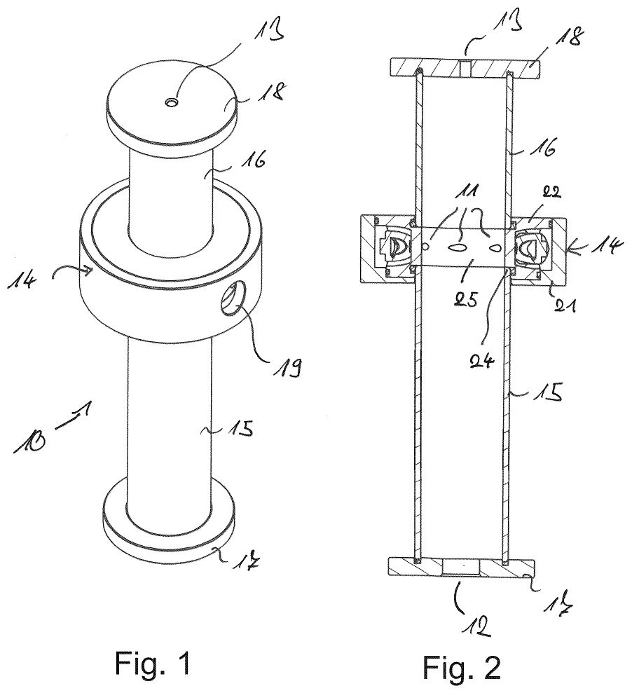

FIGS. 0A and 0B show a first and a second exemplary embodiment of a hydrocyclone degassing device according to the disclosure. Optionally In the context of this hydrocyclone degassing device a degassing vessel is used as described further below with reference to FIGS. 1-6. However, the hydrocyclone degassing devices shown in FIGS. 0A and 0B can also be operated with any other design of degassing vessel.

FIGS. 0A and 0B simultaneously show a first and a second exemplary embodiment of a pump assembly according to the disclosure and of a liquid circuit according to the disclosure.

In both exemplary embodiments of the hydrocyclone degassing device, a degassing vessel 10 is provided in which, during operation, along an axis of rotation, an outer liquid cyclone and an inner gas cyclone form, wherein the degassing vessel has at least one inlet 11 for the liquid, at least one outlet 12 for the liquid, and at least one discharge opening 13 for discharging gas.

The liquid flow from the degassing vessel 10 is controlled by a controller 100. The controller may include a processor and memory holding instructions therein for carrying out the actions as described herein, where the controller is coupled with sensors and/or actuators for measuring the parameters described herein and for actuating actuators as described herein, respectfully.

In both exemplary embodiments, for this purpose a valve 70 is provided, which is actuated via an actuator 71, wherein the actuator is actuated by the controller. In particular, the valve 70 is an electrically actuable valve, in particular the actuator 71 is a solenoid actuator and/or the valve 70 is a solenoid valve. The valve 70 is optionally a switching valve.

Alternatively, the control of the liquid flow from the degassing vessel 10 could, however, also take place by controlling a liquid pump by which the liquid flow is generated, in particular by controlling the liquid pump 60 provided in FIG. 0A.

In the exemplary embodiment, degassing takes place in each case as follows: When switching on the liquid flow, the liquid level within the degassing vessel drops below the level of the inlet 11 and a vacuum builds up in the degassing vessel 10. The liquid thereby flows along the pipe wall of the degassing vessel 10 in the direction of outlet 12. After a certain time (e.g. 60 sec), the controller 100 switches and stops the liquid flow from the degassing vessel. Liquid continues to flow through the inlet into the degassing vessel 10, namely until the degassing vessel 10 fills up and briefly an overpressure (relative to ambient pressure) forms. As a result, released gases can escape to the environment via the discharge opening. For this purpose, a corresponding valve arrangement 40, 41 is arranged at this opening. After a certain time (e.g. 15 sec), the controller 100 switches the liquid flow from the degassing vessel on again and the process starts anew. With this method, dissolved gases can be eliminated down to a few ppb.

In the exemplary embodiment, at the discharge opening a combination of a float valve 40 as a vent and a vacuum-tight check valve 41 is provided. The float valve is actuated here by the rising liquid level in the degassing vessel.

Alternatively, a combination of float valve (vent) and an electrically controlled valve or an electrically controlled valve would also be conceivable. The electrically controlled valve can be actuated by the controller in a time-controlled and/or pressure-controlled manner. For example, the valve can be actuated such that it opens at a specified time after stopping the liquid flow from the degassing vessel and closes again after a specified period of time has elapsed. Likewise, the valve can be actuated as a function of a pressure in the degassing vessel and, for example, open as soon as the pressure in the degassing vessel exceeds a specified threshold value. It can then close again after a specified period of time has elapsed and/or when falling below a second threshold value.

In both exemplary embodiments of a liquid circuit shown in FIGS. 0A and 0B, this comprises a main circuit 80 with a liquid pump 90 and a secondary circuit 50, wherein the degassing vessel 10 is arranged in the secondary circuit. The liquid pump 90 can be actuated in a demand-controlled manner, for example by a controller not shown.

The main circuit 80 can in particular be a heating and/or cooling circuit.

In the exemplary embodiment, the main circuit 80 has a flow line VL and a return line RL, wherein in the exemplary embodiment the liquid pump 90 is arranged in the flow line VL.

The secondary circuit 50 has an inlet line 51 to the degassing vessel 10 and an outlet line 52, 53 from the degassing vessel 10, which each branch off from one of the lines of the main circuit. The valve 70 is in each case provided in the outlet line 52, 53.

In the exemplary embodiment shown in FIG. 0A, the hydrocyclone degassing device comprises its own liquid pump 60, by which the liquid flow from the degassing vessel is generated. This is provided in the outlet line 52, 53, i.e. it is connected on its suction side to the outlet 12 of the degassing vessel 10.

In the exemplary embodiment shown in FIG. 0A, the valve 70, which serves to control the liquid flow from the degassing vessel, is arranged on the pressure side of the liquid pump 60 and stops the flow with the pump running.

The hydrocyclone degassing device is arranged in FIG. 0A on the return line RL of the main circuit. However, it could also be arranged on the flow line VL.

In the exemplary embodiment shown in FIG. 0B, by contrast, the hydrocyclone degassing device comprises no separate liquid pump. Here, the liquid flow from the degassing vessel is instead generated by the liquid pump 90 of the main circuit. For this purpose, the return line 53 opens into the main circuit on the suction side of the liquid pump 90, while the inlet line 51 branches off from the main circuit on the pressure side of the liquid pump.

In the exemplary embodiment shown in FIG. 0B, the hydrocyclone degassing device is accordingly arranged on the flow line VL of the main circuit.

In order for the hydrocyclone degassing device to function, the pump used to generate the liquid flow from the degassing vessel must provide a relevant negative pressure on the suction side. Typical heating-circuit pumps, for example, would not be suitable for this. In the embodiment shown in FIG. 0B, in which the liquid pump 90 of the main circuit is used to generate the liquid flow from the degassing vessel, it must therefore be equipped with a corresponding suction capability. In the embodiment shown in FIG. 0A, the liquid pump 60 must have a suction capability.

For example, a liquid pump 60/90 with a suction head of over 1 m, for example of 9 m, can be used. However, pumps with lower suction heads would also be conceivable.

Unlike, for example, vacuum spray-tube degassing, in the exemplary embodiment the control of the liquid flow is not pressure-controlled but time-controlled. In particular, the switching on and off of the liquid flow can take place independently of the pressure in the degassing vessel. Furthermore, the pressure profile in the degassing vessel also differs fundamentally from the pressure profile in vacuum spray-tube degassing. While namely the pressure in the spray tube in vacuum spray-tube degassing has an essentially sinusoidal profile, in the exemplary embodiment of the present disclosure, when switching off the liquid flow the negative pressure in the degassing vessel rises quickly and remains at this value while the liquid flow is maintained. Only when switching off the liquid flow does the negative pressure drop quickly. During the first operating phase with the liquid flow switched on, the degassing vessel is therefore at an essentially constant negative-pressure level.

According to the present disclosure, the control of the liquid flow optionally takes place in a time-controlled manner, for example in regular intervals. Accordingly, the degassing also takes place essentially quasi-continuously, that is, in a cycle in which operating phases with liquid flow and phases in which the gas is discharged by switching off the liquid flow regularly alternate.

If the hydrocyclone degassing device is used as a separate unit with its own liquid pump 60 as in FIG. 0A, the liquid pump 60 is optionally operated with a constant volumetric flow rate. Accordingly, the control for switching on and off the liquid flow can take place with fixed switching times.

If, by contrast, the hydrocyclone degassing device as in FIG. 0B is used together with the liquid pump 90 of the main circuit, in particular of a heating system, then due to the control of the liquid pump 90 independent of the degassing, there is no continuous liquid flow from the degassing vessel. It can therefore be provided to make the switching times of the valve 70, via which the degassing phases are controlled, dependent on the operation of the liquid pump 90.

The hydrocyclone degassing device according to the disclosure can in particular be installed stationary in a liquid circuit, in particular a heating and/or cooling circuit.

In the embodiment shown in FIG. 0B, the hydrocyclone degassing device can in particular be integrated into the pump assembly of the main circuit.

With the solution according to the disclosure, significantly better degassing values can be achieved compared with spray degassing, but also compared with hydrocyclone degassing devices known from the prior art. While conventional spray degassing installations only achieve degassing values of approx. 100-200 ppm, with the hydrocyclone degassing device according to the disclosure, in the exemplary embodiment values of 10-20 ppm are obtained, and thus a degassing quality which can keep up with membrane or vacuum degassing installations.

FIGS. 1 and 2 now show an exemplary embodiment of a degassing vessel as can be used in a hydrocyclone degassing device according to the disclosure.

The degassing vessel 10 has an interior space into which liquid flows via one or more inlets 11 and in which, in the interior space of the degassing vessel, along an axis of rotation of the degassing vessel, forms an outer liquid cyclone and an inner gas cyclone. Furthermore, an outlet 12 for the liquid and a discharge opening 13 for discharging gas are provided. The outlet 12 of the degassing vessel is, as already described above, in hydraulic connection with the suction side of the liquid pump 60 or 90.

In the exemplary embodiment shown in FIGS. 1 and 2, the one or more inlets 11 are arranged in an inlet ring 14. As a result, the relatively complex geometry of the inlets can be provided in a separate element which is connected to the other elements of the degassing vessel.

The inlet ring 14 has a liquid inlet 19 to which the inlet line 51 for the liquid to be degassed is connected. From the liquid inlet 19, the liquid to be degassed flows within the inlet ring to the inlet 11 or the plurality of inlets via which the liquid flows into the interior space of the degassing vessel.

The inlet ring 14 has an annular inner circumferential surface 25 into which the inlets 11 open, and which forms a part of the inner circumferential surface of the degassing vessel.

The inlet ring 14 is connected to one or more shell elements 15, 16 of the degassing vessel, which provide the remaining inner circumferential surface of the degassing vessel.

In the exemplary embodiment, the inlet ring 14 is arranged between a lower shell element 15 and an upper shell element 16. The inner circumferential surfaces of the one or more shell elements are optionally flush with the inner circumferential surface 25 of the inlet ring 14.

In the exemplary embodiment, the degassing vessel has a circular-cylindrical interior space. The inventors of the present disclosure have recognized that the actually hyperbolically shaped liquid cyclone also forms in such a housing shape, and therefore more complex housing shapes can be dispensed with. The shell elements 15 and 16 can thereby be formed by hollow-cylindrical pipe elements. These likewise have a circular cross-section.

The degassing vessel 10 is closed at the top and bottom by closure plates 17 and 18. The upper closure plate 18 is placed on the upper shell element 18 and closes it upward; the lower closure plate 17 is placed on the lower shell element 15 at the bottom and closes it downward.

The upper closure plate 18 has a central bore 13 which forms the suction opening for suctioning gas. The lower closure plate 17 likewise has a central bore 12 which serves as an outlet for the liquid.

In the exemplary embodiment of the degassing vessel, the outlet of the liquid therefore takes place axially. The inventors of the present disclosure have recognized that the effort necessary for a tangential outlet is not necessary and that an axial outlet also leads to a good degassing performance.

In the exemplary embodiment, the inlet ring 14 has, above and below the inner circumferential surface 25, a step-shaped flange 24, against which the shell elements 15 and 16 are fitted. Sealing takes place via sealing rings which engage at the outer periphery of the shell elements 15, 16 and run in grooves at the inner periphery of the step of the inlet ring.

The inlet ring has a shell part 21 on which the liquid inlet 19 is arranged, and into which a liquid-conducting ring element 22 is inserted axially.

Between the shell part 21 and the liquid-conducting ring element 22 an annular space is formed via which the liquid flows from the liquid inlet 19 to the inlet regions.

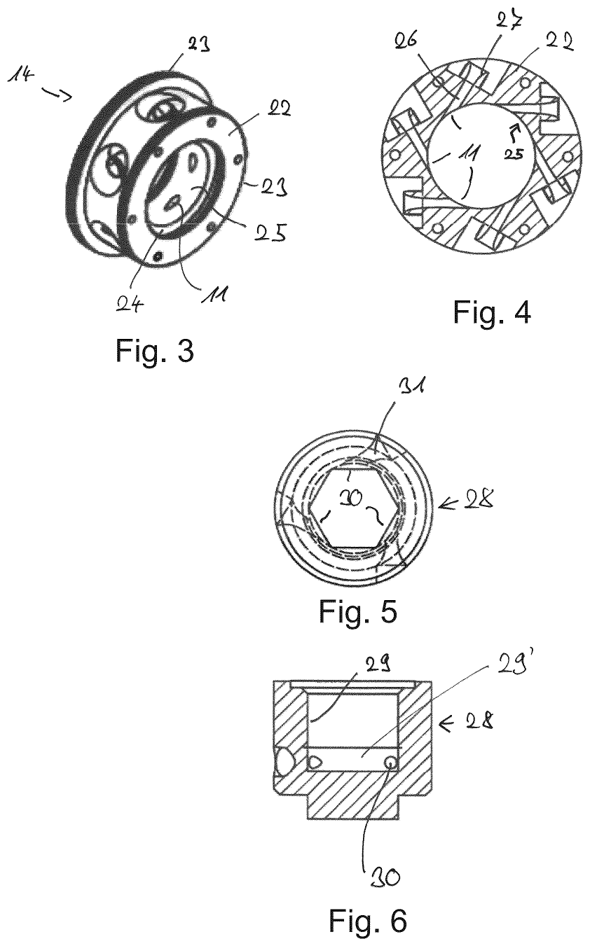

FIGS. 3 and 4 show an exemplary embodiment of the liquid-conducting ring element 22. This is inserted in a sealing manner into the shell part 21 via O-ring seals 23.

The liquid-conducting ring element 22 serves as a swirl generator for the liquid flowing into the degassing vessel. From the outer periphery of the liquid-conducting ring element, inlet channels 26 lead in each case to the inlets 11 into the degassing vessel. The inlet channels 26 are arranged such that the liquid flows tangentially into the interior space of the degassing vessel via the inlets 11. In particular, an axis of the inlet channels 26 runs tangentially to the surface of the inner circumferential surface 25 in the region of the respective inlet 11.

The inlet channels 26 each have a tapering cross-section and thus form inlet nozzles. The cross-section can taper in particular conically or hyperbolically.

According to a first variant of the present disclosure, the inlet channels 26 are directly connected to the annular space via which they are supplied with liquid from the liquid connection 19. In this case, the liquid optionally flows largely laminarily through the inlet channels to the respective inlet.

According to a second variant, by contrast, at the inlet of the inlet channels 26 a primary swirl element 28 is provided via which the liquid flows in a swirled manner into the inlet channels 26. By means of the primary swirl elements, the degassing performance can be increased once again.

An exemplary embodiment of such a primary swirl element 28 is shown in FIGS. 5 and 6. In the exemplary embodiment, the primary swirl element has a cap shape and is arranged with its inner periphery at an outer periphery of the inlet region 27 of the inlet channels 26.

The primary swirl element 28 has one or more primary inlets 30 via which liquid flows tangentially into the primary swirl element. The liquid rotating in this manner then flows further into the access channel 26 and from there to the respective access 11 into the degassing vessel.

For this purpose, the primary swirl element 28 has one or more primary inlet channels 31 which run through a shell region of the primary swirl element to the primary inlets 30. The primary inlet channels 31 each have a cross-section tapering in the flow direction and therefore form nozzles. The cross-section can taper in particular conically or hyperbolically.

The primary swirl element closes the access channel at its inlet in the axial direction and guides the liquid tangentially into it. The primary accesses 30 are for this purpose arranged in a region 29′ of the inner circumferential surface of the primary swirl element which, after arrangement at the inlet region 27 of the access channel 26, adjoins axially the inlet to the access channel.

An inner periphery 29 of the primary swirl element is arranged at the outer periphery of the access region 27; for example, the primary swirl element is pushed onto the inlet region 27 or screwed to it.

In the exemplary embodiment, the inlet regions 27 for the inlet channels 26 are recessed into an outer periphery of the liquid-conducting ring element, in particular milled into it.

Likewise, the inlet channels 26 as well as the primary access channels 31 are optionally milled into the respective elements.

In the exemplary embodiment, the inlets 11 into the degassing vessel are arranged axially spaced from the discharge opening 13 and/or the upper closure plate 18. In particular, the upper shell element 16 is arranged between the inlet ring 14 and the upper closure plate 18. As a result, it is prevented that liquid is suctioned off via the discharge opening 13.

In alternative embodiments, however, the inlets 11 or the inlet ring 14 could also be arranged directly below the discharge opening 13 and/or the upper closure plate 18.

Optionally, the one or more inlets 11 or the inlet ring 14 are arranged in a region between the axial center of the degassing vessel and the degassing opening 13 and/or upper closure plate 18. Particularly optionally, however, the one or more inlets 11 or the inlet ring are arranged axially spaced therefrom, in particular by at least 5% of the axial extent of the degassing vessel, more optionally by at least 10%. In particular, the axial spacing can be at least 20% of the axial extent of the degassing vessel.

The axial height of the inner circumferential surface 25 of the inlet ring is optionally less than 20% of the axial extent of the degassing vessel, more optionally less than 10% of the axial extent.

Optionally, a plurality of, in particular three, inlets 11 to the degassing vessel 10 and/or a plurality of, in particular three, primary inlets or primary inlet channels 31 are provided.

The degassing vessel can be assembled into a unit by clamping elements not shown in the figures, for example in the form of rack bars or tension bolts which run axially from the upper closure plate 18 to the lower closure plate 17. The tension elements can pass through corresponding openings in the inlet ring 14. Alternatively, they can also each be connected to the inlet ring 14.

The individual components of the degassing vessel described above can each also be used independently of one another as part of an otherwise differently designed degassing vessel.

In particular, the interior space of the degassing vessel can be shaped conically and/or hyperbolically. For example, differently configured shell elements 15 and/or 16 can be used for this.

1. Hydrocyclone degassing device for degassing a liquid, comprising a degassing vessel in which, during operation, along an axis of rotation, an outer liquid cyclone and an inner gas cyclone form, wherein the degassing vessel comprises at least one inlet for the liquid, at least one outlet for the liquid, and at least one discharge opening for discharging gas,
wherein
the hydrocyclone degassing device is configured such that, for discharging gas from the degassing vessel, the liquid flow from the degassing vessel is stopped and/or reduced so that the liquid level within the degassing vessel rises due to the liquid flowing in via the inlet.

2. Hydrocyclone degassing device according to claim 1, comprising a controller which controls the liquid flow from the degassing vessel such that, in a first operating phase, the liquid level is lowered by the liquid flow from the degassing vessel and a negative pressure is generated in the degassing vessel, wherein, along an axis of rotation, an outer liquid cyclone and an inner gas cyclone form, and, in a second operating phase, the liquid flow from the degassing vessel is stopped and/or reduced so that the liquid level within the degassing vessel rises due to the liquid flowing in via the inlet, wherein gas is discharged from the discharge opening.

3. Hydrocyclone degassing device according to claim 2, wherein the controller is configured such that the hydrocyclone degassing device is operated alternately in the first and second operating phase.

4. Hydrocyclone degassing device according to claim 2, wherein the controller carries out the change from the first to the second operating phase in a time-controlled manner.

5. Hydrocyclone degassing device according to claim 4, wherein a liquid pump which generates the liquid flow from the degassing vessel is operated in the first operating phase always with the same volumetric flow rate and/or the same power and/or the controller switches from the first to the second operating phase at fixed time intervals,
or
wherein a liquid pump which generates the liquid flow from the degassing vessel is operated in the first operating phase with a variable volumetric flow rate and/or a variable power and/or independently of the operation of the hydrocyclone degassing device and/or the time intervals at which the controller switches from the first to the second operating phase depend on an operating value of the liquid pump and/or a value of the liquid flow from the degassing vessel.

6. Hydrocyclone degassing device according to claim 1,
comprising a valve arranged in an outlet line, via which the liquid flow from the degassing vessel is controlled,
and/or
comprising a liquid pump which generates the liquid flow from the degassing vessel.

7. Hydrocyclone degassing device according to claim 1, wherein at the discharge opening at least one valve is provided which allows a discharge of the gas.

8. Hydrocyclone degassing device according to claim 7, wherein the hydrocyclone degassing device is configured such that the at least one valve is closed for generating negative pressure in the degassing vessel by the liquid flow and/or at least during a part of the first operating phase and/or opens for discharging the gas from the degassing vessel and/or during at least a part of the second operating phase.

9. Hydrocyclone degassing device according to claim 7, wherein the at least one valve is not actuated by the controller.

10. Hydrocyclone degassing device according to claim 1, wherein the degassing vessel is configured such that the liquid flows tangentially into the degassing vessel via the at least one inlet and/or wherein the degassing vessel is configured such that the liquid is withdrawn axially from the degassing vessel via the at least one outlet,
and/or
wherein the at least one inlet is provided in an inlet ring which adjoins axially at least one shell element of the degassing vessel,
and/or
wherein the at least one inlet is arranged in a region between an axial center of the degassing vessel and an axial end at which the discharge opening is provided, and/or wherein the at least one inlet is arranged axially spaced from an axial position of the discharge opening in the axial direction toward the outlet side,
and/or wherein in an inlet line to the at least one inlet into the degassing vessel a primary swirl element is provided.

11. Pump assembly, comprising a liquid pump and a hydrocyclone degassing device according to claim 1.

12. Liquid circuit with a hydrocyclone degassing device according to claim 1.

13. Liquid circuit according to claim 12, wherein the degassing vessel is arranged in a secondary circuit parallel to a main circuit, wherein in the secondary circuit downstream of the degassing vessel a liquid pump is arranged, wherein the liquid flow from the degassing vessel is controlled by controlling the liquid pump and/or by controlling a valve which is arranged in the secondary circuit downstream of the degassing vessel.

14. Liquid circuit according to claim 12, wherein the degassing vessel is arranged in a secondary circuit parallel to a main circuit, wherein in the main circuit parallel to the secondary circuit a liquid pump is arranged which generates in the secondary circuit the liquid flow from the degassing vessel.

15. Method for operating a hydrocyclone degassing device and/or a pump assembly and/or a liquid circuit according to claim 1, wherein, for discharging gas from the degassing vessel, the liquid flow from the degassing vessel is interrupted and/or reduced so that the liquid level within the degassing vessel rises due to the liquid flowing in via the inlet.

16. Method according to claim 15, wherein the liquid flow from the degassing vessel is controlled such that, in a first operating phase, the liquid level is lowered by the liquid flow from the degassing vessel and a negative pressure is generated in the degassing vessel, wherein, along an axis of rotation, an outer liquid cyclone and an inner gas cyclone form, and, in a second operating phase, the liquid flow from the degassing vessel is stopped and/or reduced so that the liquid level within the degassing vessel rises due to the liquid flowing in via the inlet, wherein gas is discharged from the discharge opening.

17. Hydrocyclone degassing device according to claim 1, wherein the at least one inlet is provided in an inlet ring which adjoins axially at least one shell element of the degassing vessel and is arranged between two shell elements of the degassing vessel, wherein the inlet ring comprises a plurality of inlets distributed over the circumference which open tangentially into an inner circumferential surface of the inlet ring, and/or wherein the inlet ring has an inner circumferential surface which adjoins an inner circumferential surface of the at least one shell element and is flush with it.

18. Hydrocyclone degassing device according to claim 1, wherein in an inlet line to the at least one inlet into the degassing vessel a primary swirl element is provided, wherein the primary swirl element comprises at least one primary swirl housing with at least one tangential inlet and an axial outlet.

19. Hydrocyclone degassing device according to claim 2, wherein the controller is configured such that the hydrocyclone degassing device is operated in a continuous alternation between the first and second operating phase.

20. Hydrocyclone degassing device according to claim 4, wherein the discharge of the gas from the degassing vessel in the second operating phase is controlled in a mechanical, time-controlled and/or pressure-controlled manner.
